(19) United States
(12) Patent Application Publication
(10) Pub. No.: US 2006/0080172 A1
(43) Pub. Date: Apr. 13, 2006

(54) Method, system, and software for electronic media driven promotions that include off-line actions

(75) Inventors: Armen Najarian, Los Altos, CA (US); Stan Roach, Mountain View, CA (US); Robert Drescher, Menlo Park, CA (US); Juan Carlos Velten, Highland Village, TX (US); Mike Comb, San Carlos, CA (US)

Correspondence Address: VIERRA MAGEN MARCUS & DENIRO LLP, 575 MARKET STREET SUITE 2500, SAN FRANCISCO, CA, 94105, US

(73) Assignee: SoftCoin, Inc.

(21) Appl. No.: 11/226,629

(22) Filed: Sep. 14, 2005

Related U.S. Application Data
(63) Continuation-in-part of application No. 10/964,164, filed on Oct. 13, 2004.

(51) Int. Cl. G06Q 30/00

(52) U.S. Cl. 705/14

(57) ABSTRACT

A method and system, including software, encourages trial experiences of products and/or services at specified physical locations by an individual after the individual selects an electronic media, such as a Web advertisement. In an alternate embodiment, a method and system, including software, encourages an individual to purchase a product or service that may be new to the market or recently launched and when the use of unique codes included in packaging may not be used. The method includes providing an electronic media, such as a Web banner, paid search results or e-mail to an individual that selects the electronic media and inputs individual information to a server, promotional processing device or Web site. A first object is provided and there is an opportunity to obtain a second object after an individual selects the electronic media. After the individual performs an off-line action, such as test driving a vehicle, meeting with a financial consultant or viewing a selected video, a token (code) is provided to the individual. A second object then may be obtained by the individual after the code is entered and verified by a Web site. An object may include a discount on a purchase, an entry to a sweepstake, a gift certificate, a prize and/or a rebate. The prize may include downloadable music or a book. In an alternate embodiment, a second object may be obtained after an individual purchases a product or service and then verifies the purchase, by for example, answering questions at a Web site regarding the purchase.

### RELATED APPLICATIONS

The present application is a continuation-in-part of pending U.S. patent application Ser. No. 10/964,164 filed Oct. 13, 2004 entitled “Token Enhanced Media.”

### FIELD OF THE INVENTION

This invention relates generally to consumer promotions and the Internet or the World Wide Web (“www”), also known as the Web.

### BACKGROUND

There is a need to increase the effectiveness of Web advertising for consumers or individuals purchasing products or services from retailers. Product manufacturers/distributors/marketers, and similarly service providers, are interested in purchasing advertising that will effectively sell products or services. However, it is typically difficult to determine whether a particular type of advertising, such as Web advertising, is effective in causing a consumer or individual to purchase a product or service in response to viewing or experiencing a particular advertisement.

Therefore there is a need to increase the effectiveness of Web advertisement or increase the likelihood that an individual will purchase a product or service in response to a particular Web advertisement.

Further, there is a need to demonstrate how a particular Web advertisement affects individual or consumer purchasing behavior. Certain products or services are typically purchased at particular physical locations by consumers. Some products are typically purchased only after a test trial or in-person consultation. An effective Web advertisement should encourage a consumer to conduct the test trial or consultation thereby increasing the likelihood of a purchase.

There is also a need to demonstrate that a Web advertisement caused an individual to purchase a particular product without the use of codes included on or with product packaging.

### SUMMARY

A method and system, including software, encourages trial experiences of products and/or services at specified physical locations by an individual after the individual selects an electronic media, such as a Web advertisement. In an alternate embodiment, a method and system, including software, encourages an individual to purchase a product or service that may be new to the market or recently launched and when the use of unique codes included in packaging may not be used. The method includes providing an electronic media, such as a Web banner, paid search results or e-mail to an individual that selects the electronic media and inputs individual information to a server, promotional processing device or Web site. A first object is provided and there is an opportunity to obtain a second object after an individual selects the electronic media. After the individual performs an off-line action, such as test driving a vehicle, meeting with a financial consultant or viewing a selected video, a token is provided to the individual. A second object then may be obtained by the individual after the token (code) is entered and verified by a Web site. An object may include a discount on a purchase, an entry to a sweepstake, a gift certificate, a prize and/or a rebate. The prize may include downloadable music or a book. In an alternate embodiment, a second object may be obtained after an individual purchases a product or service and then verifies the purchase, by for example, answering questions at a Web site regarding the purchase.

In an embodiment, a method comprises providing and selecting an electronic media, such as a Web banner, a search result or an e-mail, by an individual. The individual obtains a first object after inputting individual information. An opportunity to obtain a second object is then identified. An individual performs an identified off-line action. A token (code) is then obtained by the individual after the individual performs the off-line action. The code then may be input and verified at a Web site to obtain a second object.

In still another embodiment, a method comprises providing and selecting an electronic media. The individual obtains a first object after inputting individual information. An opportunity to obtain a second object is then identified. An individual performs an identified off-line action, such as purchasing a new product or service that is being launched. The individual then answers questions regarding the product or service at a Web site. When the answers are verified, the individual obtains a second object.

In another embodiment, a processing device comprises a storage device coupled to a processor. The storage device stores a software program for controlling the processor. The processor is operative with the software program to obtain individual information in response to an individual selection of an electronic media and notifies of a first object. The processing device also notifies an individual of an opportunity to obtain a second object when an action is performed by the individual. The processing device verifies whether a code obtained by the individual after performing the action is valid and notifies of a second object in response to the verification of the code.

In still another embodiment, a processing device provides a question regarding a purchased product or service to the individual and receives an answer to the question. The processing device provides notification of a second object in response to verification of the answer.

Other aspects and advantages of the present invention can be seen upon review of the figures, the detailed description, and the claims which follow.

### BRIEF DESCRIPTION OF THE FIGURES

FIG. 1 illustrates a system for token enhanced media.

FIG. 2 is a method according to an embodiment of the invention.

FIG. 3a illustrates a registration form or Web page according to an embodiment of the invention.

FIG. 3b illustrates an individual's account Web page at a first time according to an embodiment of the invention.

FIG. 3c illustrates an individual's account Web page at a second time according to an embodiment of the invention.

FIG. 4 is a workflow diagram according to an embodiment of the invention.

FIG. 5 illustrates a method according to an embodiment of the invention.

FIG. 6 is a workflow diagram according to an embodiment of the invention.

FIG. 7 illustrates a method according to an embodiment of the invention.

FIG. 8 is a workflow diagram according to an embodiment of the invention.

FIG. 9 is software architecture according to an embodiment of the invention.

### DETAILED DESCRIPTION

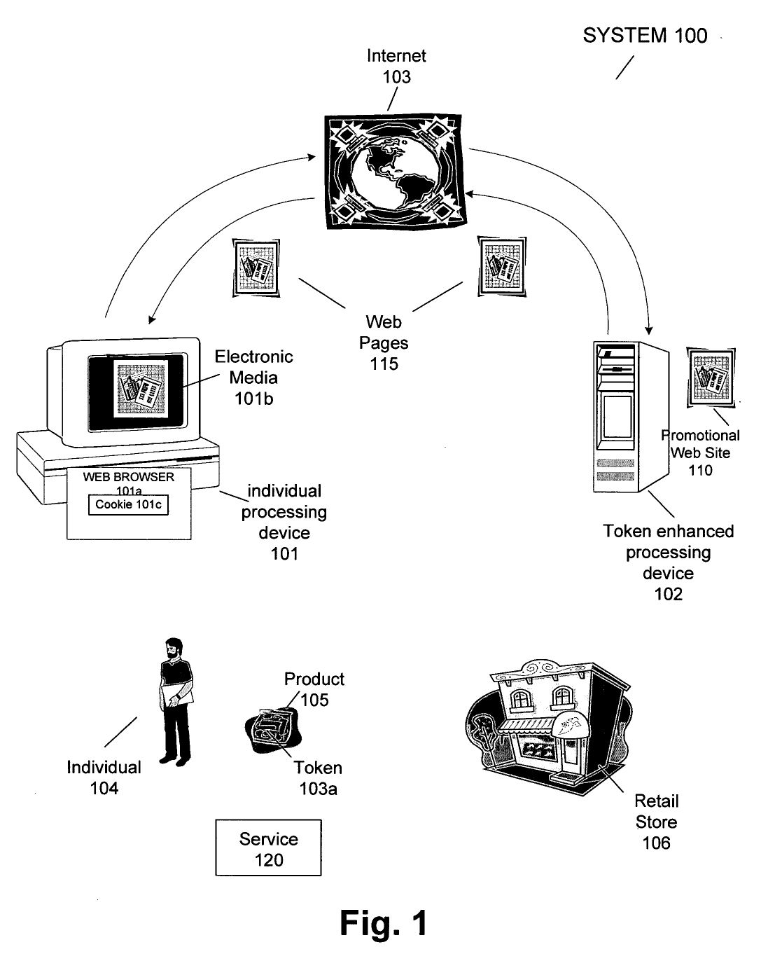

FIG. 1 illustrates a system 100 according to an embodiment of the present invention to encourage an individual 104 to purchase a product 105 (and/or service 120) in response to electronic media. In an embodiment, system 100 encourages individual 104 to obtain a trial experience of product 105 and/or service 120. In an alternate embodiment, system 100 encourages an individual 104 to purchase a product 105 and/or service 120 that has been introduced to the market and may not have a token 103a, and in particular a code. In an embodiment, system 100 identifies measurable subsequent loyalty of an individual 104 purchasing the product 105 (or service 120) from offline retailers, such as retail store 106, during a period of time. In an embodiment, product 105 is purchased from an online retailer at an online Web site. After receiving a free token in response to electronic media 101b, individual 104 purchases (or otherwise obtains) one or more products 105 and inputs one or more tokens 103a into a promotional Web site 110 in order to obtain an object, such as a gift certificate, after accumulating and inputting a predetermined number of tokens. When and where the products 105 were purchased by individual 104 are recorded by promotional Web site 110 while inputting the tokens and may be used to identify the effectiveness of the electronic media 101b during a selected period of time and the purchasing habits of individual 104.

System 100 includes individual processing device 101 and token enhanced processing device 102, coupled to Internet 103, also known as the Web. As one of ordinary skill in the art would appreciate, information is transferred between processing devices 101 and 102, by way of Internet 103, using numerous type of technologies. For example, individual processing device 101 accomplishes information transactions with processing device 102 by using the Hypertext Transfer Protocol (“HTTP”), which is a known application protocol. Individual 104 accesses, by way of individual processing device 101, Web pages 115 or documents on the Web (that may include text, graphics, images, sound and/or video) stored on Internet 103 or token enhanced processing device 102 using typically a standard page description language known as the Hypertext Markup Language (“HTML”). HTML provides basic document or Web page formatting and allows for “links” to other Web pages that may be stored on other processing devices. A Uniform Resource Locator (“URL”) having a specific syntax identifies a network path or connection to a Web page stored on a processing device. Embedded hypertext links on a particular Web page can be used to find related information. By clicking on a hypertext link in a particular Web page, individual 104 can display another related Web page or even invoke a related software program.

Retrieval of information is generally achieved by the use of an HTML-compatible “browser” 101a (for example, Microsoft® Explorer) stored on processing device 101. When individual 104 using browser 101a specifies a link via a URL, processing device 101 issues a request to a naming service to map a hostname in the URL to a particular network IP address at which the processing device or server is located. The naming service returns a list of one or more IP addresses that can respond to the request. Using one of the IP addresses, browser 101a establishes a connection to a server. If the server is available, it returns a Web page or other object formatted according to HTML. Browser 101a is an interface for accessing many network and server services.

An example of server services includes obtaining search results on a search result page from a search engine using browser 101a. An individual 104 typically may explore several relevant Web sites listed in a Web page of search results. The typical interaction is to follow a link, look at the Web page, and then hit the back button to redisplay the search results. The individual often wants to use the Web page of search results as a persistent launcher that opens the links in another specified view.

In an embodiment, individual 104 is provided with electronic media 101b on processing device 101. In an embodiment, electronic media 101b is a Web advertisement, advertisement electronic file or Web banner provided on a Web page or a Web site to advertise a product 105 or service 120 to an individual 104 viewing the electronic media 101b. A Web site is a set of interconnected web pages, usually including a homepage, generally located on the same server, and prepared and maintained as a collection of information by a person, group or organization. The electronic media 101b may include text, graphics, images, video, sound, singly or in combination.

In another alternate embodiment, electronic media 101b is a Web page displaying search results from a search engine. In embodiments, a search result may be either a sponsored (paid) search result or an organically generated search result. In an embodiment, a manufacturer/distributor/marketer has paid for at least a portion of the search results.

In still another embodiment, electronic media 101b is an e-mail provided to individual processing device 101 that may include a Web advertisement or a link to a Web site having a Web advertisement.

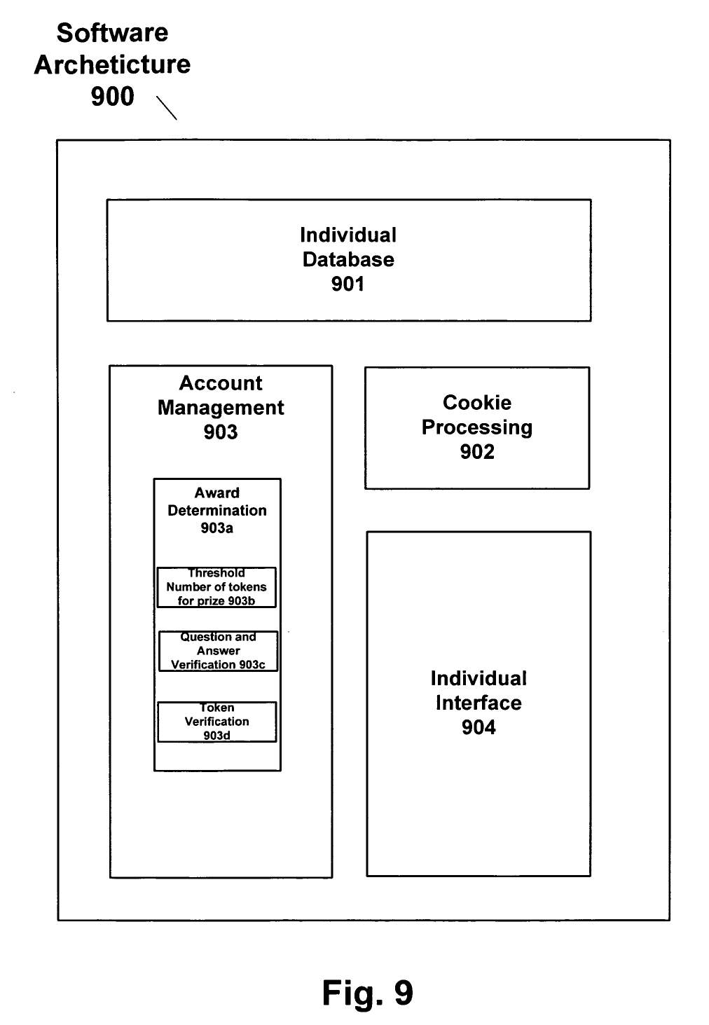

In an embodiment of the present invention, token enhanced processing device 102 shown in FIG. 1 is a server, a mainframe computer, a desktop computer or an equivalent thereof. In an embodiment, processing device 102 includes at least one general-purpose processor and machine-readable memory for storing computer software or machine-readable instructions as illustrated in FIG. 9. In an embodiment, processing device 102 has a distributed architecture or represents many processing devices having respective processors located in near or far physical proximity. In an embodiment, token enhanced processing device 102 stores a software component for providing a promotional Web site 110 that stores individual information and individual accounts storing and recording tokens obtained by individual 104. In an embodiment, processing device 102 along with software illustrated in FIG. 9, provide notification of objects to individuals. Further, processing device 102 provides challenge question and answer verification to individual 104 as described below. In an embodiment, a promotional Web site 110 is provided by software components of architecture 900 shown in FIG. 9 and described below.

In an embodiment of the present invention, individual processing device 101 shown in FIG. 1 is an information appliance, a desktop computer, handheld computer, telephone, personal digital assistant (PDA), pager or an equivalent thereof. In an embodiment, processing device 101 is coupled to Internet 103 by a wired and/or wireless connection (of which one embodiment may be a cellular network coupled to Internet 103).

In an embodiment, individual 104 purchases or obtains (e.g. by way of a free give away) a product 105 (or a service 120) having a token 103a from an off-line physical site, such as retail store 106. In an alternate embodiment, an individual obtains a product 105 from an on-line Web site. In an embodiment, individual 104 consumes or uses product 105. In an embodiment, individual 104 purchases product 105 for another individual. In an embodiment, individual 104 uses individual processing device 101 or individual 104 has others use individual processing device 101. In an embodiment, individual 104 purchases a product 105 that has been recently introduced to the market place during a product launch that has been identified by electronic media 101b. In an embodiment, product 105 does not include token 103a.

In an embodiment, product 105 is a consumable product, such as chips, soda, toothpaste, juice, etc. that is obtained from a grocery store, drug store, club store, mass merchant or convenience store. In an embodiment, product 105 is a garment, accessory or durable good obtained from a retail store. In an embodiment, product 105 is a vehicle, such as an automobile. In an embodiment, product 105 is a food item, such as a menu selection at a particular restaurant. In an embodiment, individual 104 obtains a service 120, instead of or with product 105, which may include meeting with a financial planner at a particular financial branch office.

In embodiments, token 103a includes a unique code or a plurality of alphanumeric symbols. In an embodiment, token 103a is attached to product 105 or included in product 105 packaging. A unique code is a vehicle used to verify that an actual purchase of product 105 has taken place by individual 104. In another embodiment, token 103a is included in or with product 105.

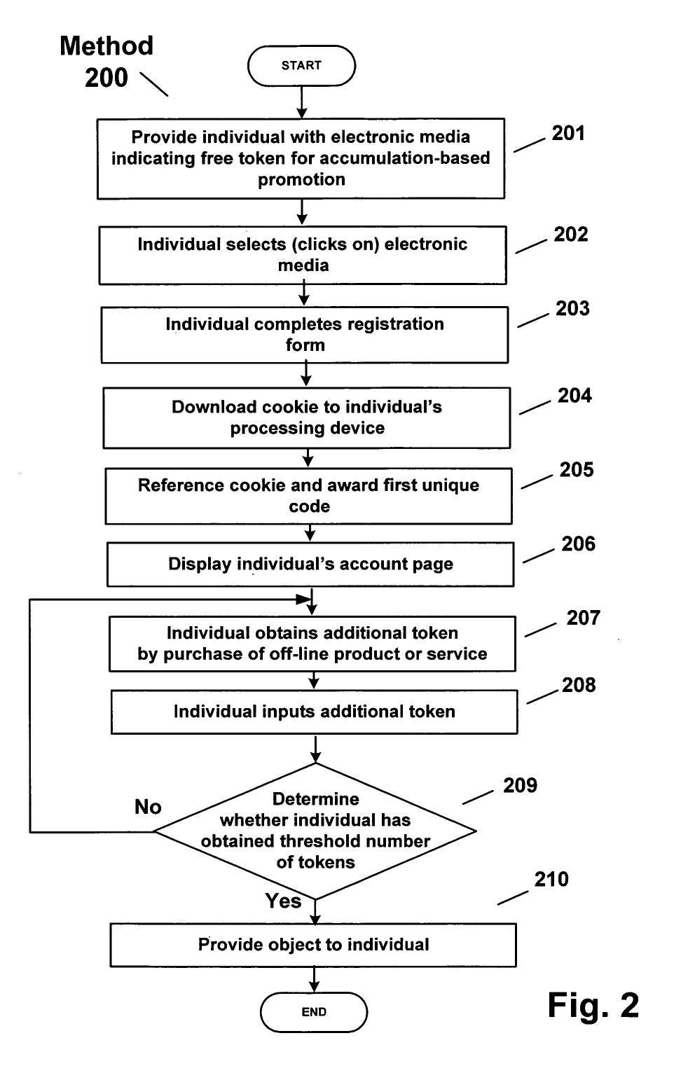

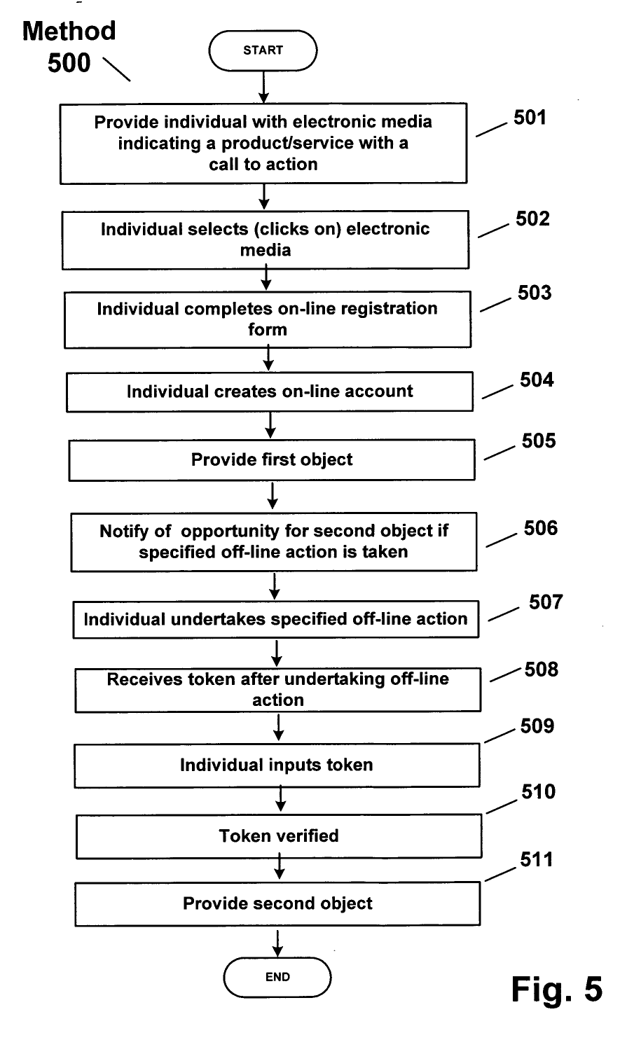

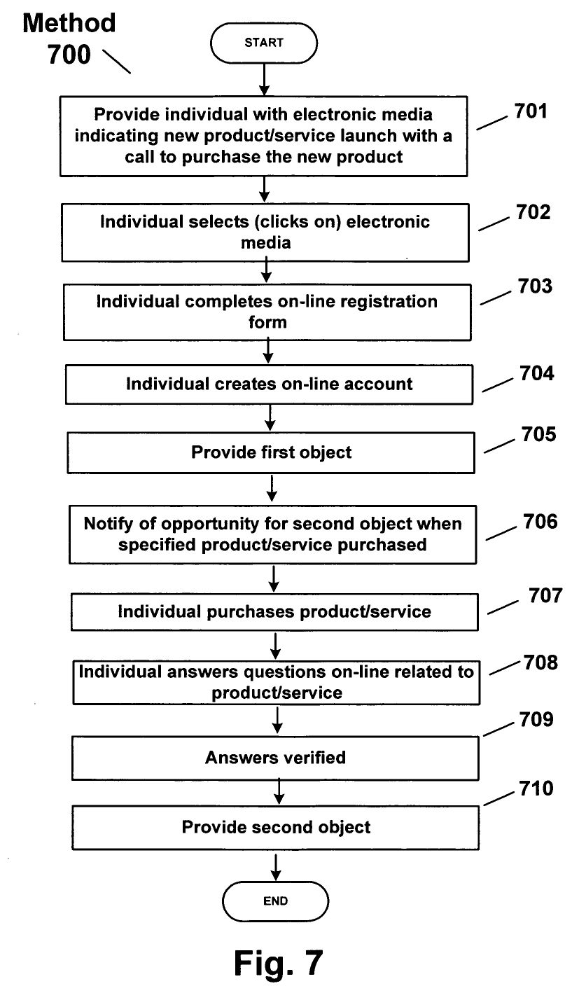

FIG. 2 illustrates a method 200 for encouraging a purchase of a product 105 or service 120 in response to electronic media 101b and identifying measurable subsequent loyalty of an individual purchasing the product from off-line/on-line retailers according to an embodiment of the present invention. As one who is skilled in the art would appreciate, FIG. 2, as well as FIGS. 5 and 7, illustrate logic boxes or steps representing the performance of specific functions. In alternate embodiments, more or fewer logic boxes or steps are used. In an embodiment of the present invention, a logic box or step may represent an execution of a software component (for example, a software program, a software object, a software function, a software subroutine, a software method, a software instance or a code fragment), a hardware operation or an individual operation, such as an individual performing some off-line action, singly or in combination.

An individual is provided with electronic media indicating a free token in an accumulation-based product or service promotion in logic block 201. In an embodiment, the electronic media is electronic media 101b shown in FIG. 1 and described above.

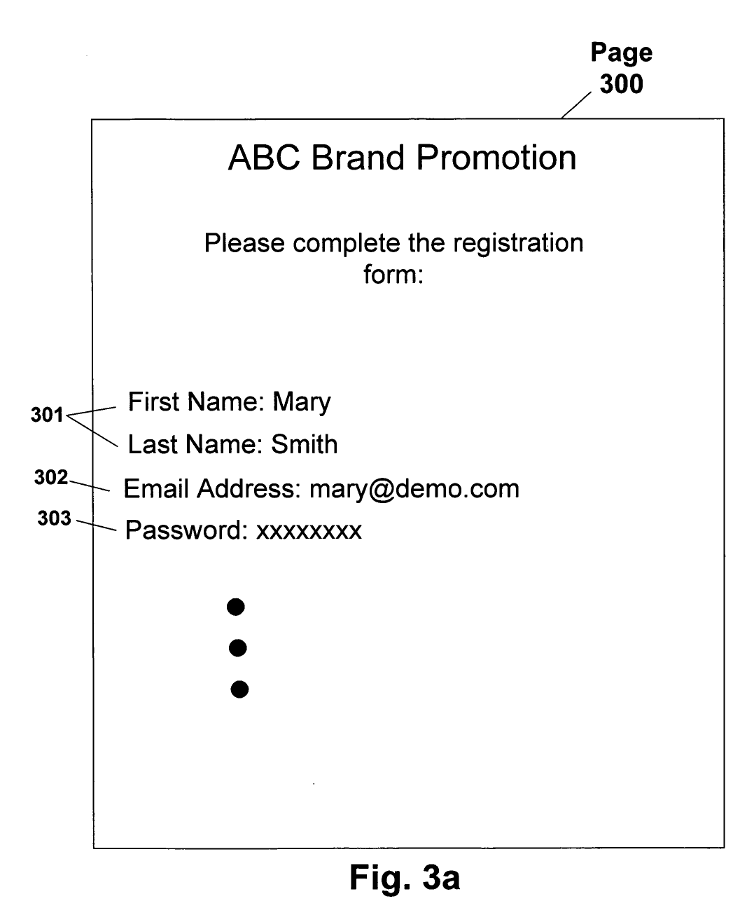

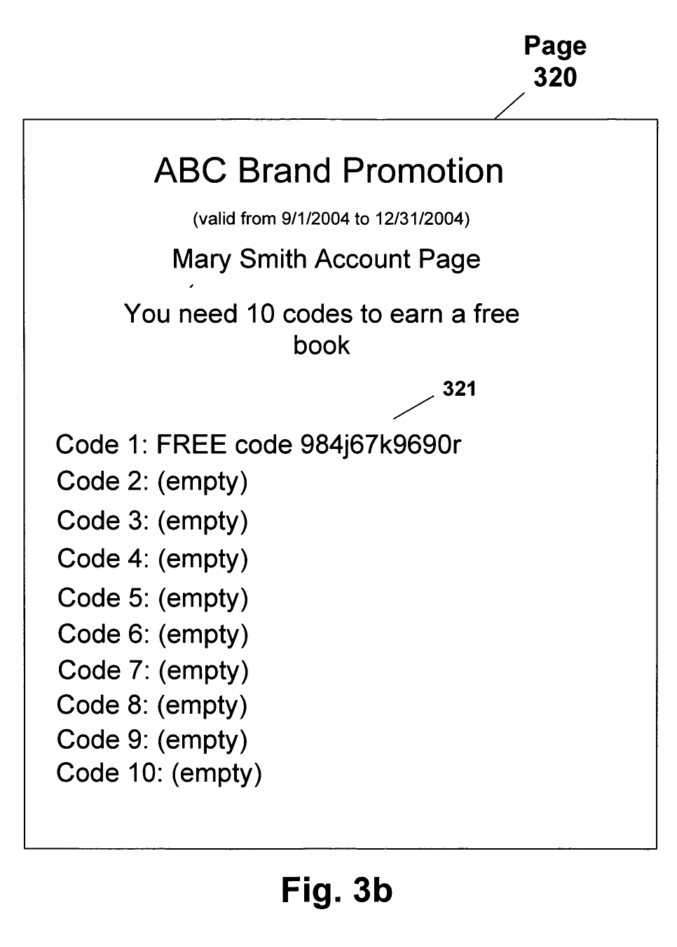

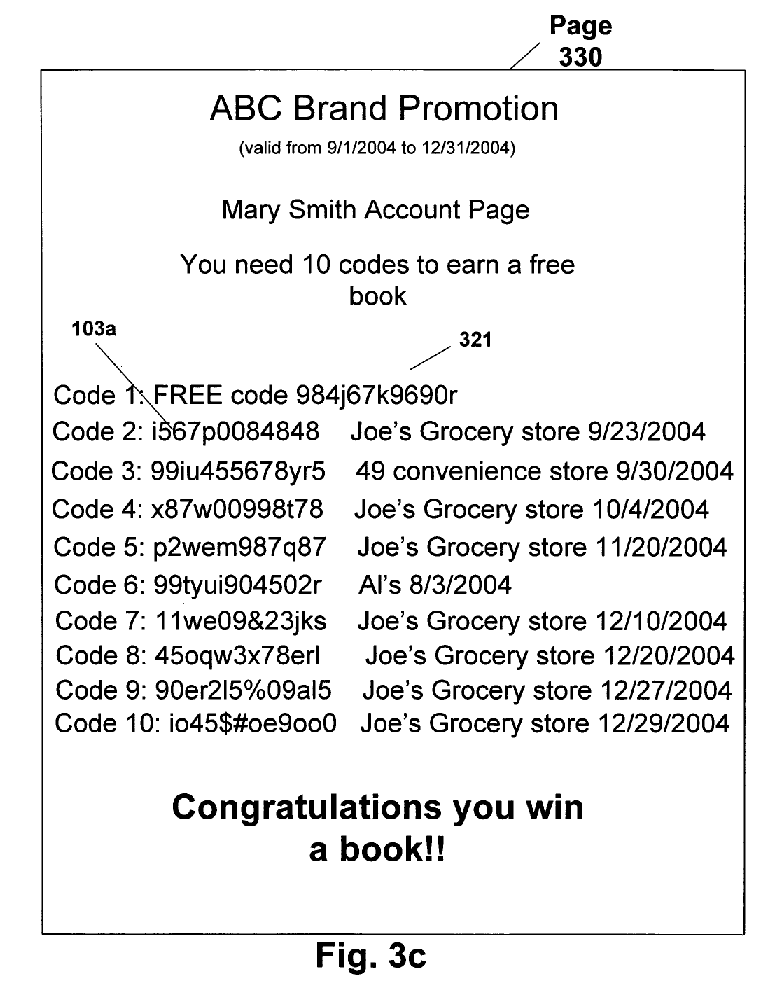

An individual selects the electronic media as shown by logic block 202. In an embodiment, an individual selects the electronic media by clicking on a Web advertisement or clicking on a link in e-mail. An individual completes a registration form in a Web page as seen in logic block 203. A Web page 300, as shown in FIG. 3a, is provided by processing device 102 to processing device 101 in an “ABC Brand Promotion” in an embodiment. Individual 104 inputs a name 301, e-mail address 302 and selected password 303 in Web page 300 which is then transferred back to processing device 102, and in particular promotional Web site 110, in an embodiment. Other individual information may also be input to Web page 300 in alternate embodiments.

A cookie, such as cookie 101c shown in FIG. 1, is then downloaded to processing device 101 from processing device 102 as illustrated by logic block 204. A cookie, in an embodiment, is an executable machine-readable instruction set or software component that identifies an individual 104, in particular an individual processing device used by individual 104. In an alternate embodiment, a cookie is a general mechanism which a server, such as token enhanced processing device 102, can use to store and retrieve information from a client, such as individual processing device 101, in a client-server network. A cookie is a small piece of information sent by a server or a Web site to store on a client, such as processing device 101, so it can later be read back from that client. This is useful for having the client remember some specific information. In an embodiment, cookie 101c is written to individual processing device 101 by processing device 102. Cookie 101c provides individual information of individual 104 whenever processing device 102 requests the information in an embodiment.

In an alternate embodiment, a cookie is not used and a unique session identification (or sessionid) is generated when individual 104 visits a promotional Web site during a user session. The sessionid or user identification number is used to uniquely identify an individual. The sessionid is then stored in a cookie on the individual's processing device or embedded in any link an individual may click on. A sessionid request is defined as a request that has sessionid information in addition to the request itself. The session continues as long as the individual stays in the links of the first Web page or pages generated from links in the first Web page. A session expires when its age reaches the lifetime set by the server. Information can then be stored on the server and associated with the individual's sessionid. This allows the server to maintain information about a specific individual without relying on a cookie for each piece of information.

A first token is then provided to an account of individual 104 in processing device 102 as illustrated by logic block 205. An individual's (“Mary Smith”) account Web page is provided to processing device 101 as shown by logic block 206. In an embodiment, an individual's account Web page 320 indicates an awarded free token 321 in ABC Brand Promotion. Further, Web page 320 indicates the number of tokens that must be obtained (ten including the free token) during a selected period of time (from Sep. 1, 2004 to Dec. 31, 2004) by buying ABC Brand product from off-line retailers and inputting the tokens associated with or included with the purchased ABC Brand products in an individual's account. Also, in an embodiment, Web page 320 indicates the object, such as a prize awarded to individual 104. In an embodiment, an object such as an incentive or gift, as well as the necessary number of tokens needed, is shown in electronic media 101b.

An individual then obtains one or more additional tokens by purchasing more products or services associated with the promotion as seen by logic block 207. In an embodiment of the invention, an individual goes to an off-line retail store to purchase a product having one or more tokens. The individual then enters the token into processing device 101 after accessing the individual's account at promotional web site 110 as represented by logic block 208. In an embodiment, the individual also enters the location of the purchase (for example “Joe's Grocery store,” “49 convenient store”, “Al's” as seen in FIG. 3c) and the purchase date that is recorded and stored by promotional web site 110.

In an alternate embodiment, tokens are not obtained but points or point values are obtained when making a verified purchase of a product or service and an individual is awarded an object if a predetermined number of points are accumulated during a period of time.

Marketers are then able to analyze individual or group purchasing habits and the effectiveness of an electronic media or Web advertisement. For example, Web page 330 indicates an individual Mary Smith who made a significant number of purchases toward the end of the promotion. If other individuals have similar buying habits, a marketer may be able to estimate or predict purchases toward the end of a promotion based on purchases toward the beginning of the promotion. Further, a marketer is able to quantify how many products were purchased during a period of time in response to a particular electronic media. If a significant number of products were purchased and recorded at promotional Web site 110 in response to a particular electronic media, a marketer will be more likely to purchase that electronic media.

A determination is then made whether the individual has obtained the necessary number of tokens for a object as seen in logic block 208. If the individual has not obtained enough unique codes, the individual repeats logic steps 207 and 208 until the necessary number of tokens is obtained. Otherwise, an individual is notified of the awarded object, such as a prize, as shown by logic block 210. In an embodiment, individual 104 receives a book as indicated by Web page 330 shown in FIG. 3c.

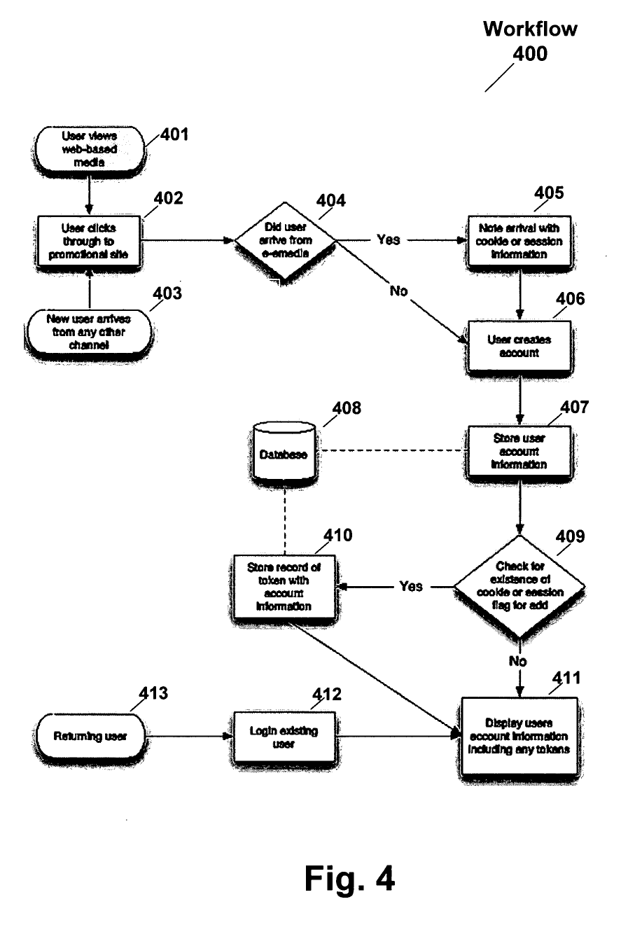

FIG. 4 illustrates a workflow 400 according to an embodiment of the invention. An individual/user views Web-based media or electronic media as illustrated by block 401. An individual/user then selects or clicks on the Web-based media as represented by logic block 402. In an alternate embodiment, an individual/user enters a promotional site through a different channel. For example, a friend tells the individual of the promotional Web site or the individual finds the promotional Web site in response to a query at a search engine. A determination is then made whether the individual arrived to the promotional Web site by way of the electronic media as indicated by logic block 404. If the individual did enter by way of electronic media, a cookie is downloaded to the individual's processing device as illustrated by logic block 405 and control transfers to logic block 406. In an alternate embodiment, a user identification number, as described above, is generated when an individual first visits the promotional Web site and used to uniquely identify an individual rather than a cookie. If the individual did not enter by way of electronic media, the individual then creates an individual account. Individual account information is stored in a database 408 illustrated by logic block 407. A determination is made whether an individual processing device has stored a cookie in logic block 409. If the individual processing device has a stored cookie indicating a free token, the information is stored in database 408 as illustrated by logic block 410. Otherwise, individual account information indicating the number of recorded tokens, where purchased and purchase date is provided or displayed to an individual/user as shown by logic block 411.

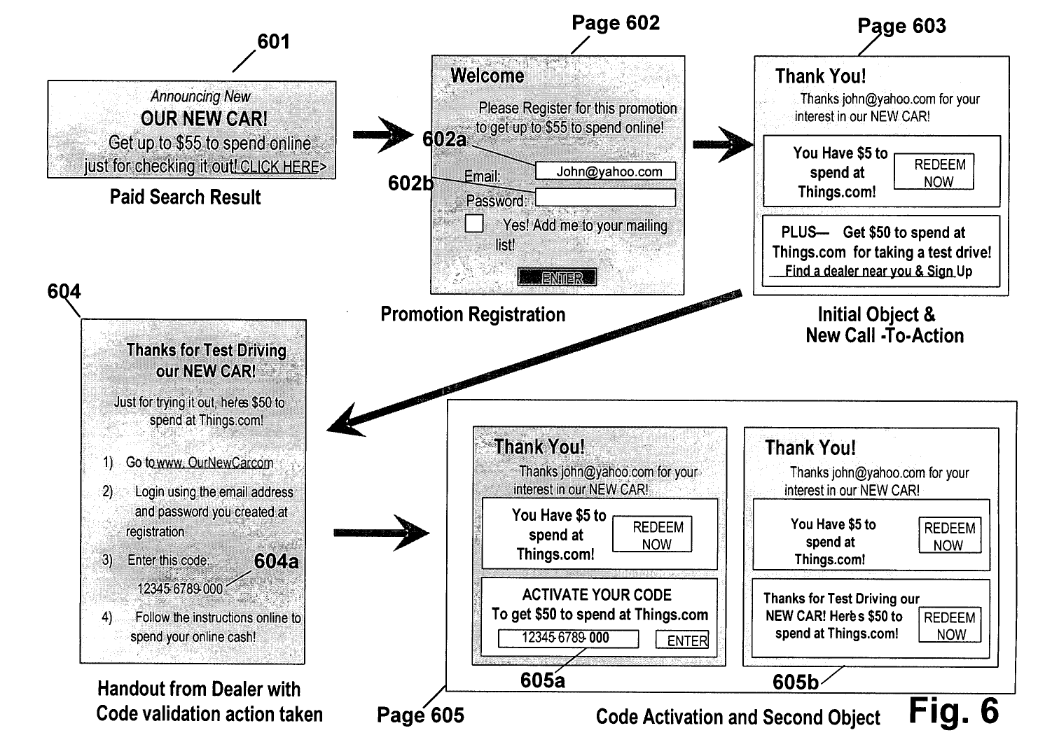

FIGS. 5 and 6 illustrate a method 500 according to an embodiment of the present invention. Method 500 generally relates to offering an object to an individual that completes a trial experience, such as test driving an automobile, purchasing a selected menu item at a selected restaurant or meeting with a financial consultant at selected financial branch office.

In an embodiment, method 500 begins by providing an individual 104 with an electronic media 101b indicating a product 105 and/or service 120 and a call to action as illustrated by logic block 501 and paid search results 601. An individual 104 selects an electronic media by, for example, clicking on a Web advertisement or clicking on a link in e-mail as illustrated by logic block 502. An individual completes a registration form in a Web page as seen in logic block 503. A Web page 602, as shown in FIG. 6, is provided by processing device 102 to processing device 101 in an “OUR NEW CAR!” promotion in an embodiment. Individual 104 inputs an e-mail address 602a and selected password 602b in Web page 602 which is then transferred back to processing device 102, and in particular promotional Web site 110, in an embodiment. Other individual information may also be input to Web page 602 in alternate embodiments.

In an embodiment, individual 104 answers survey questions during registration. In an embodiment, survey questions may include the last date of purchasing a particular product or current income level. The answers to the survey questions may then be provided to the location of the trial experience so that a salesman or associate may use the answers to provide individual 104 with a product 105 or service 120 that best meets their needs.

After individual 104 creates an on-line account, as illustrated by logic block 504, individual 104 is notified of receiving a first object and an opportunity to receive a second object on completing an off-line action, as shown by Web page 603 and illustrated by logic blocks 505 and 506. In an embodiment, individual 104 receives a $5 discount for purchasing a product at a on-line retailers, Things.com, as well as a $50 discount when individual 104 test drives a selected automobile at a selected automobile dealership. In an embodiment, the second object has a substantially greater value than the first object in order to encourage the off-line action.

Individual 104 then undertakes the specified off-line action as illustrated by logic block 507. In an embodiment, off-line action is defined as an action completed or attempted by an individual at a physical location that does not require the use of the Internet. In an embodiment, the off-line action requires individual 104 to complete a test trial of a product 105 or service 120 at a specified physical location, such as a car dealership, chain restaurant or financial branch office. Upon completing the off-line action that may only include going to the specified physical location, individual 104 receives a token 604a as illustrated by logic block 508-509 and handout 604. In embodiments, token 604a is a unique alpha numeric code or code that is not unique that is printed on handout 604. In an embodiment, token 604a is provided to individual 104 without using a handout 604.

As illustrated by logic block 509, individual 104 inputs token 604a into Web site 110, and in particular a field 605a of web page 605 shown in FIG. 6. The token 604a is then verified by Web site 110 as illustrated by logic block 510. Individual 104 is then notified of receiving a second object, such as a $50 discount at on-line retailer Things.com, as illustrated by Web page 605b and logic block 511. An individual 104 then may redeem the object by selecting buttons or links, such as a “REDEEM NOW” button or link.

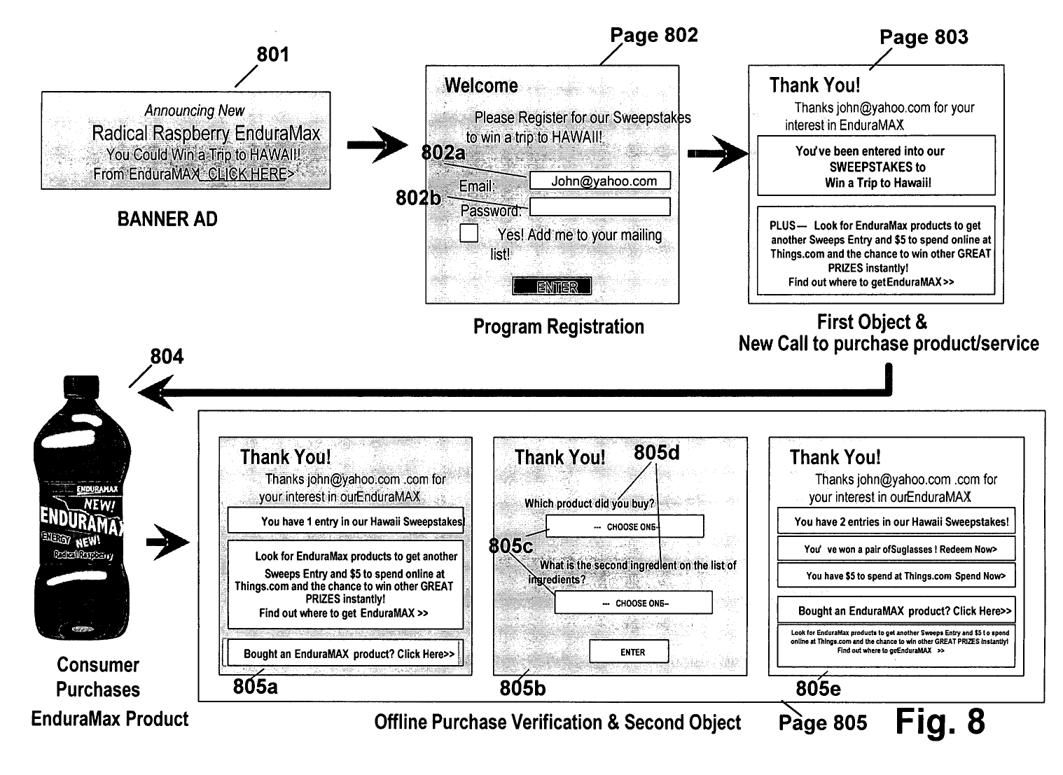

FIGS. 7 and 8 illustrate a method 700 according to an embodiment of the present invention. Method 700 generally offers an object to an individual 104 that purchases a new product 105 and/or service 120 that is introduced into the market, wherein the new product and/or service does not include a token. Ownership of the new product 105 or completion of service 120 is verified by an individual 104 answering questions regarding the new product 105 or service 120 at a Web site 110. When ownership is verified, an object is provided.

In an embodiment, method 700 begins by providing an individual 104 with an electronic media 101b indicating a product 105 and/or service 120 that is being introduced into the market as illustrated by logic block 701 and banner advertisement 801. An individual 104 selects an electronic media by, for example, clicking on Web advertisement 801 (“CLICK HERE”) for “Radical Raspberry EnduraMax” product 804 as illustrated by logic block 702. An individual completes a registration form in a Web page as seen in logic block 703. A Web page 802, as shown in FIG. 8, is provided by processing device 102 to processing device 101 in a Radical Raspberry EnduraMax promotion in an embodiment. Individual 104 inputs an e-mail address 802a and selected password 802b in Web page 802 which is then transferred back to processing device 102, and in particular promotional Web site 110, in an embodiment. Other individual information may also be input to Web page 802 in alternate embodiments.

In an embodiment, individual 104 answers survey questions during registration. In an embodiment, survey questions may include the type of drinks consumed. The answers to the survey questions may then be used in consumer purchasing analysis.

After individual 104 creates an on-line account, as illustrated by logic block 704, individual 104 is notified of receiving a first object and an opportunity to receive a second object when a specified product and/or service is purchased, as shown by Web page 803 and illustrated by logic blocks 705 and 706. In an embodiment, individual 104 receives a first object that is an entry to a sweepstakes for a trip to Hawaii and another entry to the sweepstakes and a $5 discount to spend at Things.com for a second object. In an embodiment, the second object has a greater value than the first object in order to encourage the purchase of product 105 and/or service 120.

Individual 104 then purchases a specified product 105 and/or service 120 at an off-line retailer, distributor or manufacturer as illustrated by logic block 707. After purchasing the product 105 or service 120, individual 104 returns to Web site 110 to answer challenge questions regarding the product 105 and/or service 120 as illustrated by logic blocks 708 and Web page 805a-b. In particular, individual 104 enters answers into fields 805c to challenge questions 805d regarding product 105 and/or service 120 at Web page 805b. These challenge questions are provided to verify ownership of product 105 and/or service 120. In an embodiment, questions 805d include “What is the second ingredient on the list of ingredients?”

Answers regarding the product 105 and/or service 120 are then verified by Web site 110, and in particular processing device 102 as illustrated by logic block 709. Individual 104 is then notified of obtaining a second object as illustrated by logic block 710 and Web page 805e.

FIG. 9 illustrates a software architecture 900 representing software components stored and executed, at least partially, by token enhanced processing device 102. In an embodiment of the present invention, software 900, or software components of software 900, illustrated by FIG. 9 is stored in an article of manufacture, such as a computer readable medium. For example, software 900 may be stored in a magnetic hard disk, an optical disk, a floppy disk, Compact Disk Read-Only Memory (CD-ROM), Random Access Memory (RAM), Read-Only Memory (ROM), Electrically Erasable Programmable Read-Only Memory (EEPROM) or other readable or writeable data storage technologies, singly or in combination. In an embodiment, software 900 is stored on a computer readable medium associated or included with token enhanced processing device 102.

Software 900 includes multiple software components. For example, software 900 includes individual database 901, account management 903 including award determination 903a having a threshold value of tokens for prize value 903b, question and answer verification 903c, and toke verification 903d, cookie processing 902 and individual interface 904.

Individual database 901 stores individual information including individual names, e-mail addresses, passwords, number of tokens, and when and where the tokens were obtained. In alternate embodiments, other individual information is stored and retrieved from individual database 901. In an embodiment, each individual stored in individual database 901 has an associated unique user identification number.

Account management software 903 is responsible for storing and retrieving information from an individual account in individual database 901, including the recorded number of tokens an individual has input and has been awarded. Account management software 903 also includes award determination 903a for determining whether an individual has won or may be awarded an object in response to a comparison of the number of tokens recorded in an individual's account stored in database 901 and threshold value 903b. Award determination 903a also includes question and answer verification 903c for providing questions regarding a new product and to verify that the answers are correct in order to determine that individual 104 purchased product 105 and/or service 120. Award determination also includes token (or code) verification for verifying that a code entered by individual 104 is correct.

Cookie processing software 502 is responsible for downloading a cookie, such as cookie 101b, to an individual processing device as well as writing to and reading from the downloaded cookie. In an alternate embodiment, cookie processing software 502 is replaced with user identification software that generates user identification numbers for uniquely identifying individuals as described above.

Individual interface software 504 is responsible for providing a promotional Web site and in particular information, such as Web pages 300, 320, 330, 602, 603, 605, 802, 803 and 805 to an individual as well as retrieving information, such as tokens (codes) and individual information from individuals that have been provided by way of an individual processing device and the Internet. Individual interface 504 is also responsible for transferring information between individual processing device 101 and token enhanced processing device 102.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method comprising:
providing an electronic media;
selecting the electronic media;
inputting individual information;
providing a first object;
identifying an opportunity to obtain a second object;
performing an off-line action by an individual;
obtaining a token after performing the off-line action;
inputting the token at a web site; and
obtaining a second object.

2. The method of claim 1, wherein the electronic media is selected from the group consisting of a web banner, a search result, and an e-mail.

3. The method of claim 1, wherein the first object and second object are selected from the group consisting of a discount on a purchase, an entry to a sweepstakes, a prize, gift certificate and rebate.

4. The method of claim 1, wherein the selecting includes the individual clicking on the electronic media.

5. The method of claim 1, wherein the individual information includes an individual name, password and an individual e-mail address.

6. The method of claim 1, wherein the off-line action is selected from the group consisting of test driving a vehicle, purchasing a food item, viewing a selected video, purchasing a product, obtaining a service and meeting with a financial consultant.

7. A method comprising:
providing an electronic media to an individual;
selecting the electronic media by the individual;
inputting individual information by the individual;
providing a first object to the individual;
identifying an opportunity to obtain a second object;
purchasing a product by the individual;
providing a question regarding the product;
providing an answer, by the individual, regarding the product at a processing device;
verifying the answers; and
providing a second object.

8. The method of claim 1, wherein the electronic media is selected from the group consisting of a web banner, a search result, and an e-mail.

9. The method of claim 1, wherein the first object and second object are selected from the group consisting of a discount on a purchase, an entry to a sweepstakes, a prize, gift certificate and rebate.

10. The method of claim 1, wherein the selecting includes the individual clicking on the electronic media.

11. The method of claim 1, wherein the individual information includes an individual name, password and an individual e-mail address.

12. A processing device, comprising:
a storage device;
a processor, coupled to the storage device,
the storage device storing a software program for controlling the processor; and
the processor operative with the software program to:
obtain individual information in response to an individual selection of an electronic media;
notify of a obtaining a first object;
notify of an opportunity to obtain a second object when an action is performed by the individual; and
verify whether a token obtained by the individual after performing the action is valid; and
notify of a second object in response to the verification of the token.

13. The processing device of claim 12, wherein the electronic media is selected from the group consisting of a web banner, a search result, and an e-mail.

14. The processing device of claim 12, wherein the first object and second object are selected from the group consisting of a discount on a purchase, an entry to a sweepstakes, a prize, a gift certificate and rebate.

15. The processing device of claim 12, wherein the individual information includes an individual name, password and an individual e-mail address.

16. The processing device of claim 12, wherein the action is selected from the group consisting of test driving a vehicle, purchasing a food item, watching a video, purchasing a product; obtaining a service and meeting with a financial consultant.

17. The processing device of claim 12, wherein an individual processing device provides the individual information to the processing device by way of the Internet.

18. The processing device of claim 12, wherein the individual processing device is a mobile device.

19. A processing device, comprising:
a storage device;
a processor, coupled to the storage device,
the storage device storing a software program for controlling the processor; and
the processor operative with the software program to:
obtain individual information in response to an individual selection of an electronic media;
notify of receiving a first object;
notify of an opportunity to obtain a second object when the individual purchases a product; and
provide a question regarding the product to the individual; and
receive an answer to the question;
verify whether the answer is correct; and
notify of a receiving a second object in response to the verification of the answer.

20. The processing device of claim 19, wherein the processor operative with the software program to notify of an opportunity to obtain a second object when the individual purchases a service.
